(19) United States
(12) Patent Application Publication
(10) Pub. No.: US 2014/0036491 A1
(43) Pub. Date: Feb. 6, 2014

(54) END CAP AND A MANUFACTURING METHOD THEREOF

(71) Applicants: JUSTING TECHNOLOGY PTE. LTD., SINGAPORE (SG); JUSTING TECHNOLOGY(TAIWAN) PTE LTD., ZHONGLI CITY (TW)

(72) Inventors: CHIA-CHING SU, TAOYUAN (TW); CHIH-YUAN YEN, TAOYUAN (TW)

(73) Assignees: JUSTING TECHNOLOGY PTE. LTD., SINGPORE (SG); JUSTING TECHNOLOGY(TAIWAN) PTE LTD., ZHONGLI CITY (TW)

(21) Appl. No.: 13/952,085

(22) Filed: Jul. 26, 2013

(30) Foreign Application Priority Data
Aug. 3, 2012 (TW) 101128080

(51) Int. Cl. F21V 19/00

(52) U.S. Cl. CPC F21V 19/0085
USPC 362/217.17; 29/825

(57) ABSTRACT

An end cap includes a body and a conductive terminal formed integrally with the body by injection molding. The body includes an inner annular wall to assemble with a lamp tube, the conductive terminal includes two electric connecting units and a pole-like conducting unit being in the inner annular wall and containing a longitudinal through-hole. Each electric connecting unit and the pole-like conducting unit are connected together by a joining unit and each electric connecting unit is extended out of the body from a joining unit. By inserting the end cap terminal, electricity is conducted by contact to transmit electric energy, forming a structure that can be assembled easily, parts thereof can be replaced and repaired by an ordinary person, and an electric connector thereof can rotate by 360 degrees to adjust an angle of irradiation. Moreover, the end cap is formed integrally and directly to simplify the manufacturing process.

### BACKGROUND OF THE INVENTION

a) Field of the Invention

The present invention relates to an end cap and a manufacturing method thereof, and more particularly to an end cap and a manufacturing method thereof, with the functions of simplifying the manufacturing process and reducing the defective fraction.

b) Description of the Prior Art

An early fluorescent lamp tube is mostly made of glass and contains small amount of mercury. Therefore, one should be very careful when taking or installing the fluorescent lamp tube; if the fluorescent lamp tube is broken accidentally, the mercury will flow out and damage the environment. In addition, if a person touches or adsorbs the mercury by accident, then he or she may be poisoned. On the other hand, although a conventional fluorescent lamp is cheaper, its wastes can result in mercury pollution or the fluorescent lamp can be fragile.

For a new generation of the fluorescent lamp, an LED (Light Emitting Diode) is used to give out light, but the structure is still the same as the early design of the fluorescent lamp, so as to be used in an early lamp bracket.

Referring to FIG. 1, an ordinary LED lamp tube includes a hollow tube 11, a light emitting module 12 and two external modules 13, wherein the hollow tube 11 contains a base 110 that is covered by a lampshade 111. The light emitting module 12 is provided with a circuit board 120 and plural LEDs 121 disposed on that circuit board 120. In addition, the circuit board 120 is provided with a circuit that is connected electrically with the LEDs 121, and two connecting blocks 123 are disposed in proximity to two sides of the circuit board 120. The two external modules 13 are assembled at two ends of the hollow tube 11, and each external module 13 is provided with an end cap 130, a fixing block 131 and two terminals. The end cap 130 is assembled on the base 110 with a bolt 133 and the fixing block 131 is screwed on the base 110 with another bolt 133. Each terminal includes a latch block 136 and a conductive pillar 137. The latch block 136 is latched into the fixing block 131, and a side of the latch block 136 is exposed from a lower side of the fixing block 131 and is welded with the connecting block 123 on an exterior side of the circuit board 120. The conductive pillar 137 is extended from an end surface of the latch block 136 and is protruded outward from the end cap 130.

However, the prior art is provided with following shortcomings:
1. The assembling process of the external modules is tedious and complicated; therefore, the assembling cost is higher.
2. The quality of welding is difficult to be determined by naked eyes;

therefore, tiny cracks may be formed. Moreover, if the levels of welders are not consistent, the welding quality can be affected easily, thereby increasing the defective fraction.
3. An ordinary LED lamp tube is still used in a conventional lamp holder. Therefore, when an LED lamp tube is inserted into a connecting seat of a conventional lamp holder, the LED lamp tube must be rotated by 90 degrees to be energized. Accordingly, the area of irradiation of the LED lamp tube will be deviated by 90 degrees, which prohibits a lower side of the LED lamp tube from being irradiated.

### SUMMARY OF THE INVENTION

Accordingly, the primary object of the present invention is to provide an end cap and a manufacturing method thereof by which the manufacturing process can be simplified and the defective fraction can be reduced. To achieve the abovementioned object, the end cap of the present invention is provided with a body and a conductive terminal that is formed integrally with the body by injection molding, wherein the body is provided with an inner annular wall to assemble with a lamp tube, the conductive terminal is formed with two electric connecting units and a pole-like conducting unit. The pole-like conducting unit is disposed in the inner annular wall and is provided with a longitudinal through-hole. Each electric connecting unit is connected together with the pole-like conducting unit by a joining unit; whereas, each electric connecting unit is extended out of the body from the joining unit.

Accordingly, through an insertion operation of the end cap terminal, electricity is conducted by contact to transmit electric energy, thereby constituting a structure that can be assembled easily, parts thereof can be replaced and repaired by an ordinary person and an electric connector thereof can rotate by 360 degrees to adjust an angle of irradiation. In addition, the end cap is formed integrally and directly; therefore, the manufacturing process can be simplified and the defective fraction can be reduced.

By the abovementioned primary characteristics of structures, an interior of the said lamp tube is provided with a positioning slot to fix a circuit board. Two ends of the circuit board are provided respectively with a connecting seat, each connecting seat is provided with a housing and the housing is provided at least with an insertion slot. An interior of the insertion slot is provided with a terminal and a conductive plate that is connected with the terminal. The conductive plate is also extended to a side of the housing to connect electrically with the circuit board; whereas, the insertion slot provides for insertion with the pole-like conducting unit of the end cap, such that the terminal can be inserted into the longitudinal through-hole of the pole-like conducting unit to be energized.

By the abovementioned primary characteristics of structures, a slide positioning structure is further disposed between the said lamp tube and end cap. The slide positioning structure is provided at least with a rib and an annular slot to hold the rib. Two sides of the rib are provided respectively with a groove and by locking the rib with the annular slot, the lamp tube and the end cap are positioned.

The abovementioned rib is disposed on the inner annular wall of the end cap and the annular slot is disposed on an outer surface of the lamp tube in proximity to two end sides. Or, the rib is disposed on the outer surface of the lamp tube in proximity to two end sides, and the annular slot is disposed on the inner annular wall of the end cap.

The present invention also provides a method for manufacturing the end cap, including at least following steps:
Step A. A conductive material is provided;
Step B. The conductive material is stamped to form the conductive terminal that is provided with two electric connecting units and a pole-like conducting unit, with that each electric connecting unit and the pole-like conducting unit are connected together by the joining unit, each electric connecting unit is disposed at a tail end of one side of the joining unit, the pole-like conducting unit is disposed at a location in proximity to a center on the other side of the joining unit, and the pole-like conducting unit is provided with a longitudinal through-hole;
Step C. A mold is provided;
Step D. The conductive terminal is put into the mold to perform injection molding, constituting a body that encloses the conductive terminal, with that the body is formed with the inner annular wall, the pole-like conductive unit is disposed in the inner annular wall, and each electric connecting unit is extended out of the body from the joining unit.

By the abovementioned primary characteristics of structures, the said electric connecting unit is enclosed in the body at a location in proximity to the joining unit.

By the abovementioned primary characteristics of structures, the said mold is provided with a first die block and a second die block. The first and second die block is provided with a holding unit corresponding to the conductive terminal, and a mold cavity is formed opposite to the body after the first die block has been closed with the second die block.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded structural view of a conventional LED lamp tube.

FIG. 2 shows a three-dimensional structural view of an end cap of the present invention.

FIG. 3 shows a block diagram of a method for manufacturing the end cap, according to the present invention.

FIGS. 4A to 4D show schematic views of a flow process of the method for manufacturing the end cap, according to the present invention.

FIG. 5 shows an exploded structural view of the end cap that is assembled with a lamp tube, according to the present invention.

FIG. 6 shows a schematic structural view of the end cap that is assembled with the lamp tube, according to the present invention.

FIG. 7 shows a three-dimensional structural view of a slide positioning structure of the present invention.

FIG. 8 shows a schematic structural view of the slide positioning structure of the present invention.

FIG. 9 shows a schematic structural view of the end cap that rotates by 360 degrees relative to the lamp tube, according to the present invention.

FIG. 10 shows a three-dimensional structural view of another embodiment of the slide positioning structure, according to the present invention.

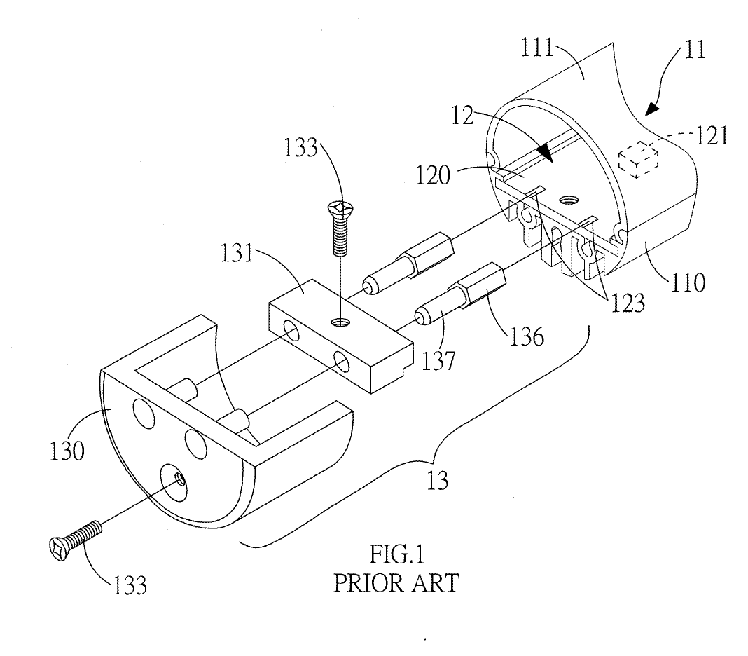

### DETAILED DESCRIPTION OF THE PREFERRED EMBODIMENTS

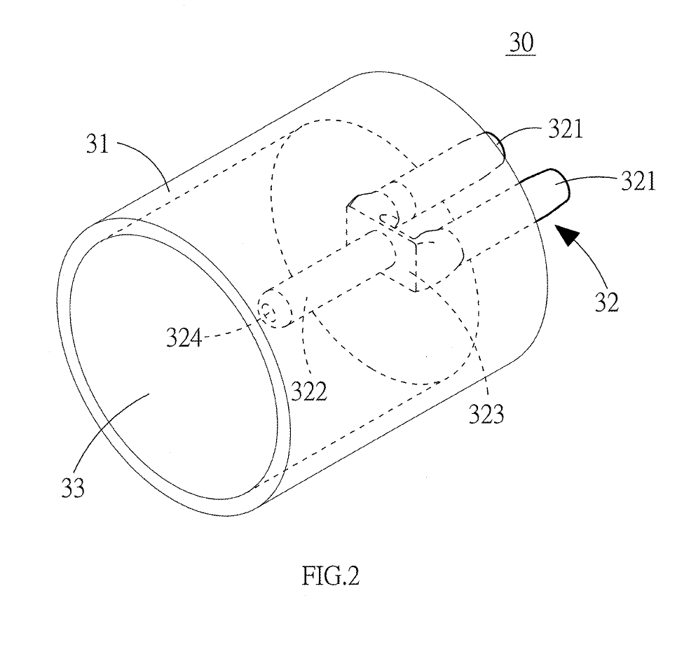

FIG. 2 discloses a three-dimensional structural view of an end cap, according to the present invention. The end cap 30 of the present invention is provided with a body 31 and a conductive terminal 32 that is formed integrally with the body 31 by injection molding. The body 31 is provided with an inner annular wall 33 to assemble with a lamp tube, the conductive terminal 32 is formed with two electric connecting units 321 and a pole-like conducting unit 322. The pole-like conducting unit 322 is disposed in the inner annular wall 33 and is provided with a longitudinal through-hole 324; whereas, each electric connecting unit 321 is connected together with the pole-like conducting unit 322 by a joining unit 323, and each electric connecting unit 321 is extended out of the body 31 from the joining unit 323.

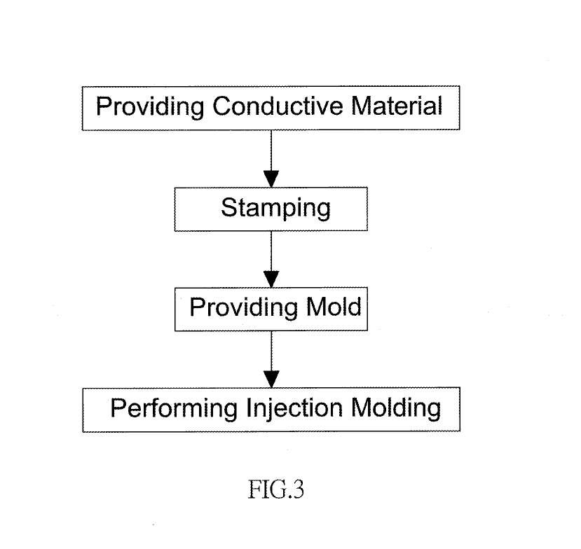

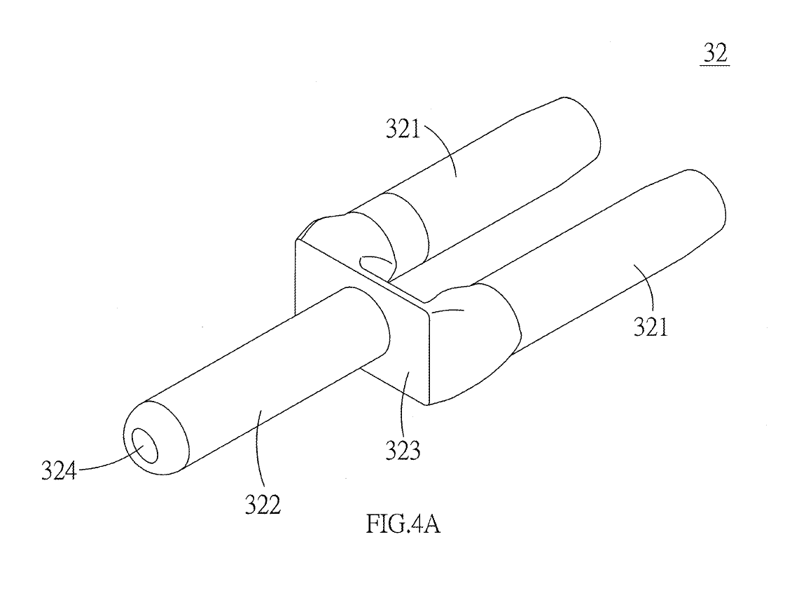

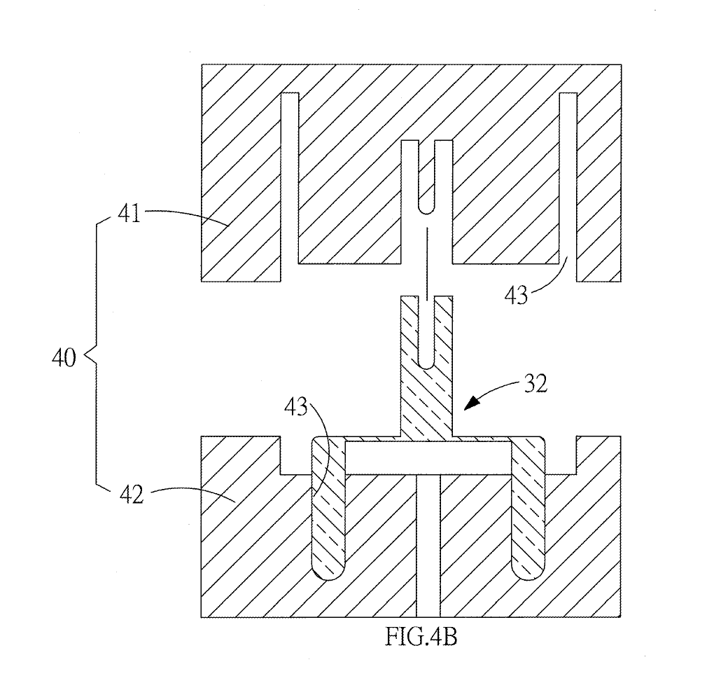

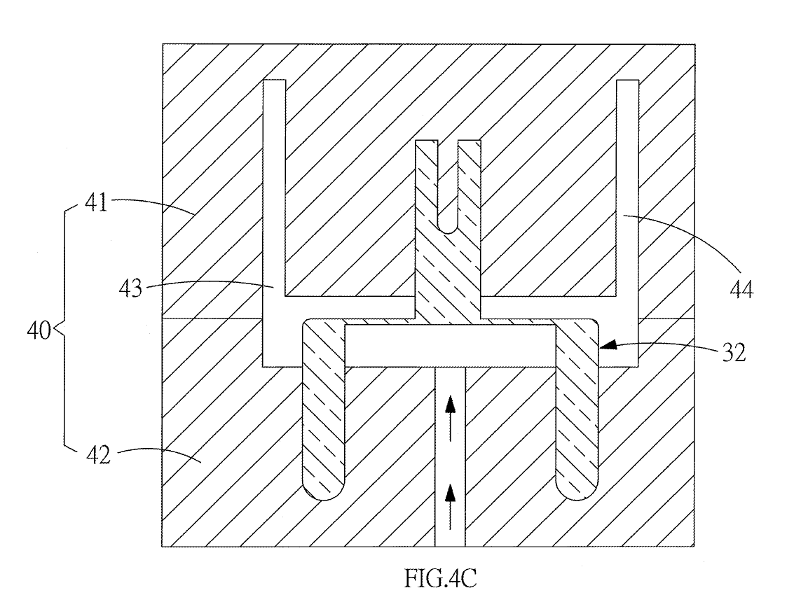

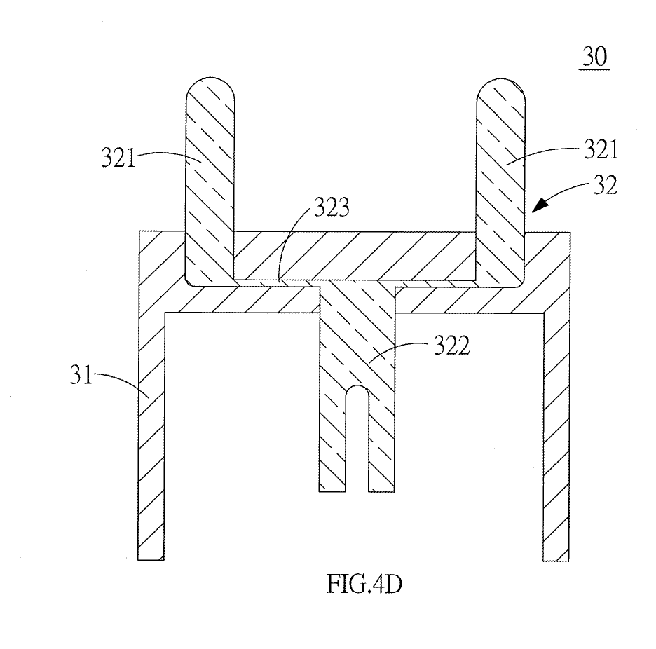

As shown in FIG. 3, the method for manufacturing the end cap comprises following steps:
Step A. A conductive material is provided;
Step B. As shown in FIG. 4A, the conductive material is stamped to constitute the conductive terminal 32, the conductive terminal 32 is formed with two electric connecting units 321 and a pole-like conducting unit 322, each electric connecting unit 321 is connected together with the pole-like conducting unit 322 by a joining unit 323, each electric connecting unit 321 is disposed at a tail end of a side of the joining unit 323, the pole-like conducting unit 322 is disposed on the other side of the joining unit 323 in proximity to a center, and the pole-like conducting unit 322 is provided with the longitudinal through-hole 324;
Step C. As shown in FIG. 4B, a mold 40 is provided, the mold 40 is provided with a first die block 41 and a second die block 42, and the first and second die block 41, 42 is provided with a holding unit 43 corresponding to the conductive terminal 32; and
Step D. As shown in FIG. 4C, the conductive terminal 32 is put into the holding unit 43 of the mold 40, the first die block 41 is closed with the second die block 42 to form a mold cavity 44 opposite to the body 31 (as shown in FIG. 4D) and injection molding is performed to form the body 31 that encloses the conductive terminal 32. As shown in FIG. 4D, each electric connecting unit 321 is enclosed in the body 31 at a location in proximity to the joining unit 323, thereby accomplishing the end cap 30.

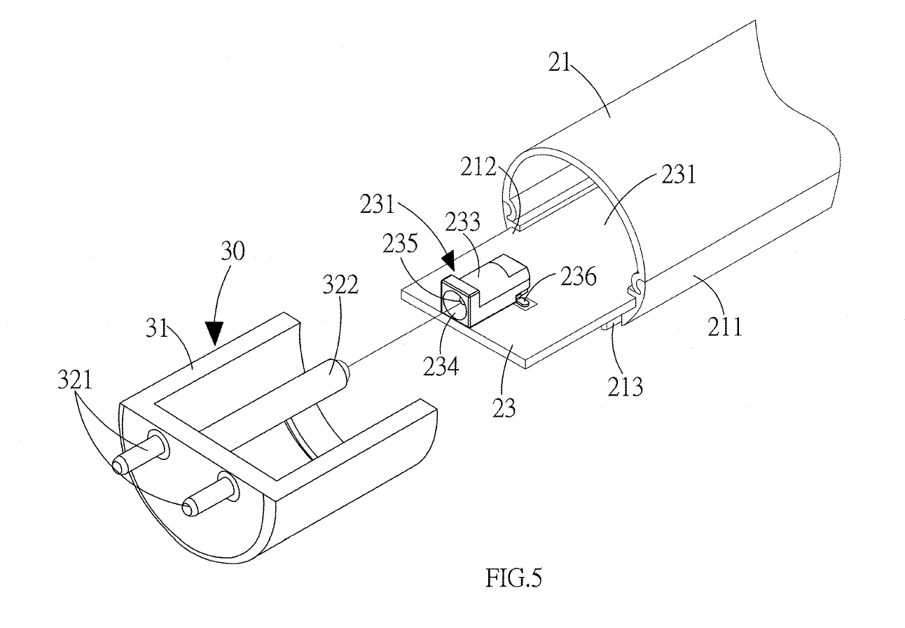

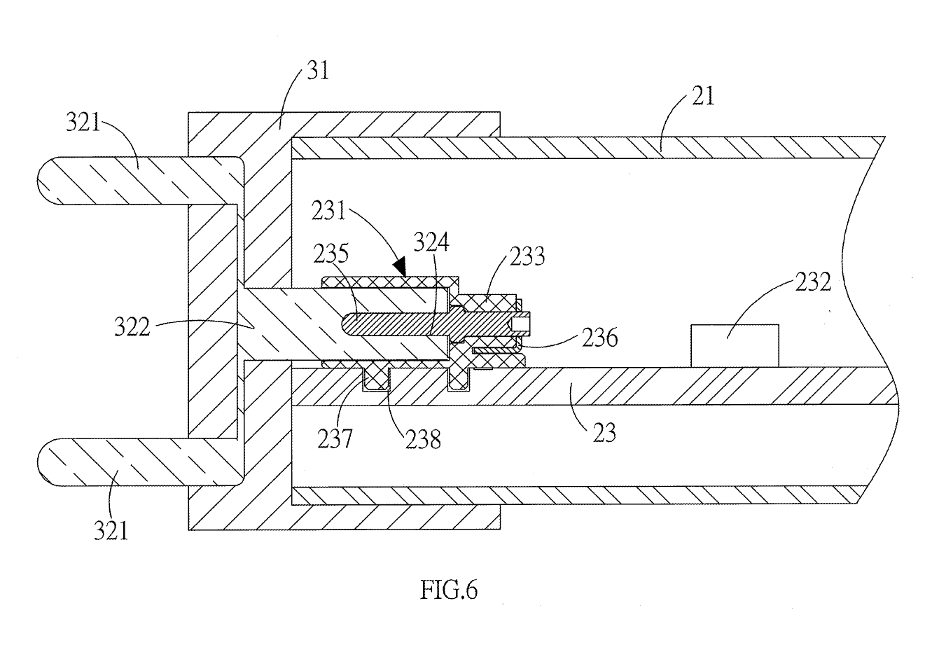

Referring to FIG. 5, it shows an exploded structural view of the end cap 30 that is assembled with the lamp tube, according to the present invention. Additionally, referring to FIG. 6, it shows a schematic structural view of the end cap that is assembled with the lamp tube, according to the present invention. An interior side of a lamp tube 21 is provided with a base 211. The base 211 is provided with a positioning slot 212 to dispose a circuit board 23. In the embodiment shown in the drawings, the lamp tube 21 is a round tube, and a lower rim of the lamp tube 21 is formed with plural cooling fins 213 to dissipate heat. On the other hand, the circuit board 23 is disposed in the positioning slot 212, and two ends of the circuit board 23 are provided respectively with a connecting seat 231. The circuit board 23 can be provided with plural LEDs 232 and the circuit board 23 is provided with a circuit (not shown in the drawings) to connect electrically with the LEDs 232; whereas, the circuit forms electric connection at the connecting seats 231.

The connecting seat 231 is provided with a housing 233. The housing 233 is provided at least with an insertion slot 234, and an interior of the insertion slot 234 is provided with a terminal 235 and a conductive plate 236 that is connected with the terminal 235. The conductive plate 236 is also extended to a side of the housing 233. In the embodiment shown in the drawings, the conductive plate 236 is extended outward from a bottom of the housing 233 and is welded on the circuit board 23 to connect electrically with the circuit board 23. The insertion slot 234 provides for insertion with the pole-like conducting unit 322 of the end cap 30, enabling the terminal 235 to be inserted into the longitudinal through-hole 324 of the pole-like conducting unit 322 for energizing. Besides that, a bottom of the housing 233 is provided at least with a positioning pillar 237 and the circuit board 23 is provided at least with a positioning hole 238 to hold the positioning pillar 237, such that the connecting seat 231 can be positioned on the circuit board 23 more stably.

When the lamp tube of the present invention is inserted into a conventional lamp holder, each electric connecting unit 321 and the pole-like conducting unit 322 will form a current loop with the circuit board 23 by the connecting seat 231, allowing the LEDs 232 to give out light by receiving electricity. Accordingly, using a simple insertion operation, the end cap can be assembled with the lamp tube, enabling the end cap and the lamp tube to be assembled easily, repaired easily, detected easily, and parts thereof replaced easily, thereby increasing the practicability.

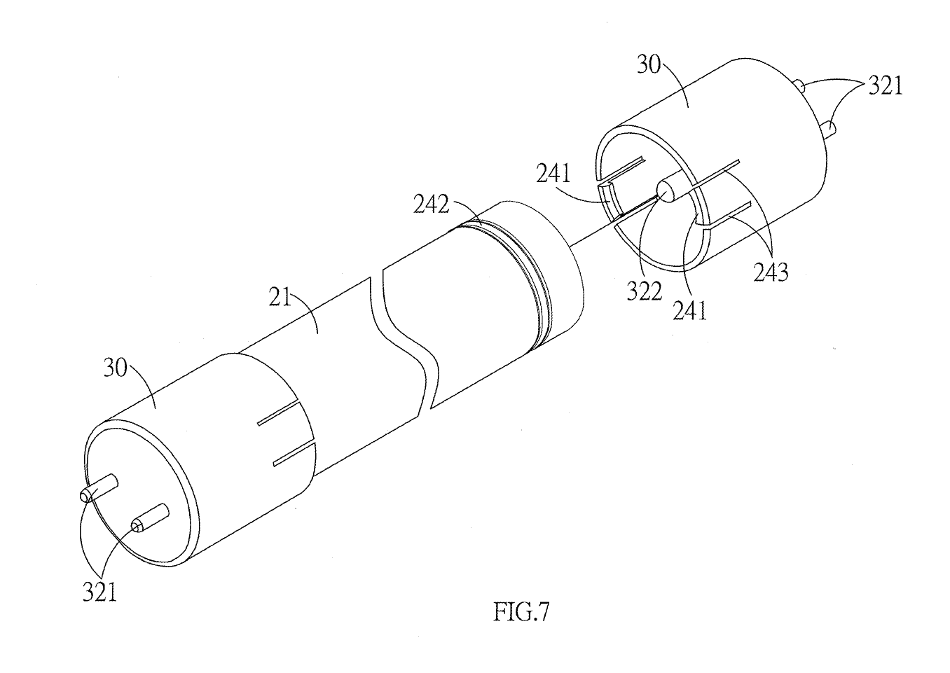

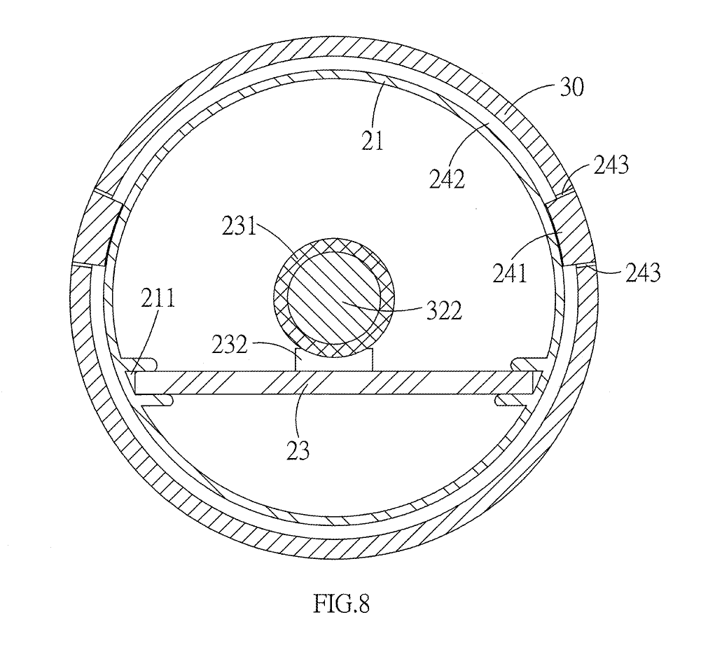

Furthermore, a slide positioning structure is further disposed between the lamp tube and the end cap. As shown in FIG. 7 and FIG. 8, the slide positioning structure is provided at least with a rib 241 and an annular slot 242 that can hold the rib 241; whereas, two sides of the rib 241 are provided respectively with a groove 243. In the embodiment shown in the drawings, the rib 241 is disposed on an inner annular wall 33 of the end cap 30, and the annular slot 242 is disposed on an outer surface of the lamp tube 21 in proximity to two end sides. Each groove 243 provides the rib 241 with elasticity to facilitate emplacing the rib 241 in the annular slot 242. By locking the rib 241 with the annular slot 242, the lamp tube 21 and the end cap 30 are positioned.

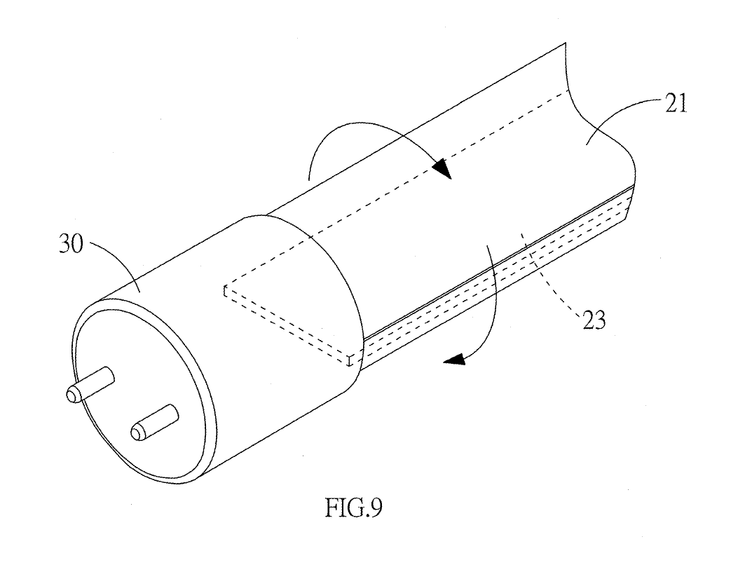

When the lamp tube of the present invention is inserted into a conventional lamp holder and a current loop is formed, the rib 241 can slide inside the annular slot 242, such that the lamp tube 21 can rotate by 360 degrees relative to the end cap 30, as shown in FIG. 9. Therefore, the lamp tube and the circuit board can rotate by a corresponding orientation to adjust an angle of irradiation.

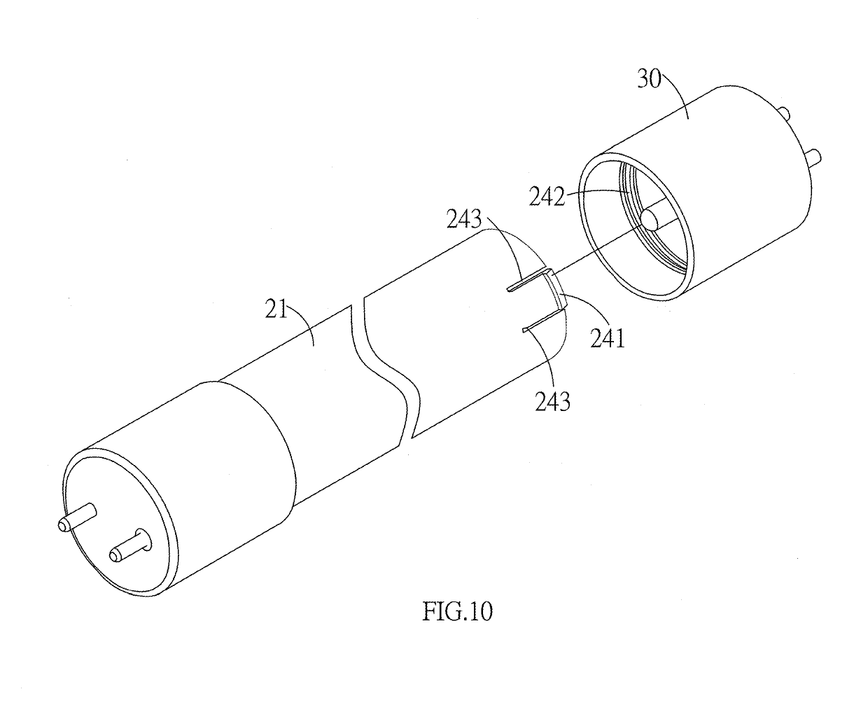

Furthermore, the rib 241 can be also disposed on the outer surface of the lamp tube 21 in proximity to two end sides, and the annular slot 242 is disposed on the inner annular wall 33 of the end cap 30, as shown in FIG. 10. This configuration also enables the lamp tube 21 and the end cap 30 to be positioned and rotate with respect to each other.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An end cap comprising:
a body, the body is provided with an inner annular wall to assemble at a tail end of a lamp tube; and
a conductive terminal, the conductive terminal is formed integrally with the body by injection molding, and the conductive terminal is formed with two electric connecting units and a pole-like conducting unit, with that the pole-like conducting unit is disposed in the inner annular wall, the pole-like conducting unit is provided with a longitudinal through-hole, each electric connecting unit is connected together with the pole-like conducting unit by a joining unit, and each electric connecting unit is extended out of the body from the joining unit.

2. The end cap according to claim 1, wherein an interior side of the lamp tube is provided with a positioning slot to fix a circuit board, with that two ends of the circuit board are provided respectively with a connecting seat, the connecting seat is provided with a housing, the housing is provided with an insertion slot, an interior of the insertion slot is provided with a terminal and a conductive plate that is connected with the terminal, the conductive plate is also extended to a side of the housing to connect electrically with the circuit board, and the insertion slot provides for insertion with the pole-like conducting unit of the end cap, thereby enabling the terminal to be inserted into the longitudinal through-hole of the pole-like conducting unit for energizing.

3. The end cap according to claim 1, wherein a slide positioning structure is further disposed between the lamp tube and the end cap, with that the slide positioning structure is provided with a rib and an annular slot to hold the rib, two sides of the rib are provided respectively with a groove, and the lamp tube and the end cap are positioned by locking the rib with the annular slot.

4. The end cap according to claim 2, wherein a slide positioning structure is further disposed between the lamp tube and the end cap, with that the slide positioning structure is provided with a rib and an annular slot to hold the rib, two sides of the rib are provided respectively with a groove, and the lamp tube and the end cap are positioned by locking the rib with the annular slot.

5. The end cap according to claim 3, wherein the rib is disposed on the inner annular wall of the end cap, and the annular slot is disposed on an outer surface of the lamp tube in proximity to two end sides.

6. The end cap according to claim 3, wherein the rib is disposed on an outer surface of the lamp tube in proximity to two end sides, and the annular slot is disposed on the inner annular wall of the end cap.

7. A method for manufacturing the end cap, comprising the following steps:
A: preparing a conductive material;
B: stamping the conductive material to constitute the conductive terminal, with that the conductive terminal is formed with two electric connecting units and a pole-like conducting unit, each electric connecting unit is connected together with the pole-like conducting unit by a joining unit, each electric connecting unit is disposed at a tail end of a side of the joining unit, the pole-like conducting unit is disposed on the other side of the joining unit in proximity to a center, and the pole-like conducting unit is provided with a longitudinal through-hole;
C: providing a mold; and
D: putting the conductive terminal into the mold to perform injection molding, forming a body that encloses the conductive terminal, with that the body is provided with an inner annular wall, the pole-like conducting unit is disposed in the inner annular wall, and each electric connecting unit is extended out of the body from the joining unit.

8. The method for manufacturing the end cap according to claim 7, wherein each electric connecting unit is enclosed in the body at a location in proximity to the joining unit.

9. The method for manufacturing the end cap according to claim 7, wherein the mold is provided with a first die block and a second die block, the first and second die block is provided with a holding unit corresponding to the conductive terminal, and a mold cavity is formed opposite to the body after the first die block has been closed with the second die block.

10. The method for manufacturing the end cap according to claim 8, wherein the mold is provided with a first die block and a second die block, the first and second die block is provided with a holding unit corresponding to the conductive terminal, and a mold cavity is formed opposite to the body after the first die block has been closed with the second die block.
